(19) United States
(12) Patent Application Publication
(10) Pub. No.: US 2025/0312801 A1
(43) Pub. Date: Oct. 9, 2025

(54) APPARATUS AND METHOD FOR COMMINUTING AND MIXING SOLIDS

(71) Applicant: HS-TUMBLER GMBH, Quakenbrück (DE)

(72) Inventor: Bernhard Hukelmann, Quakenbrück (DE)

(21) Appl. No.: 18/872,655

(22) PCT Filed: Jun. 12, 2023
(86) PCT No.: PCT/EP2023/065649

§ 371 Date: Dec. 6, 2024

(30) Foreign Application Priority Data
Jun. 13, 2022 (DE) 102022205973.5

(51) Int. Cl. B02C 18/12; A47J 43/25; B02C 18/22

(52) U.S. Cl. CPC B02C 18/12; A47J 43/25; B02C 18/2291

(57) ABSTRACT

The invention relates to an apparatus for comminuting solids into pieces, in particular solid foodstuffs into foodstuff pieces, which has a container at the first end cross-sectional opening of which at least one knife is arranged, the first cross-sectional opening forming an inlet opening or being covered by a first lid, which has an inlet opening, the container being driven in a reciprocating motion parallel to or at an angle to the plane in which the first cross-sectional opening extends, with a feed chute, the outlet opening of which is arranged in the region of the first cross-sectional opening and the opposite inlet opening of which is spaced from its outlet opening.

### SUMMARY

The invention relates to an apparatus and a method, preferably carried out using the apparatus, for comminuting and/or mixing solids, e.g. food raw materials, e.g. for use as a household food processor. The solids can be waste materials to be recycled, e.g. batteries, composite materials with glass, ceramics, plastic and/or metal, or electronic waste.

The apparatus and the method have the advantage of comminuting solids and mechanically stressing the pieces thereof in a container, optionally mixing them intensively with additives. The apparatus and the method have the advantage of comminuting solids which are solid foodstuffs, e.g. food raw materials, in particular those of vegetable origin, e.g. vegetables, fruit, or foodstuffs of animal origin, e.g. meat products or sausage products or cheese, and collecting them in a container in which the pieces of food produced by the comminution can optionally be additionally mixed with additives and/or be softened by mechanical stress. Additives are e.g. table salt, spices, vinegar, cooking oil, raw food materials are preferably raw plant parts, e.g. vegetables, e.g. cabbage, potatoes, sweet potatoes, leeks, onions, root vegetables etc., or fruit, e.g. apples. In an embodiment, the apparatus is characterized in that it has at least one cutting edge, also representatively referred to as a knife, which is fixed to the container and/or optionally a mixing element is fixed in the container. Preferably, the container has no mixing element that is movable relative to the container, in particular no stirrer, so that the container is designed without a bearing for a movable mixing element.

The apparatus has the advantage of cutting solids, e.g. solid foodstuffs, wherein the pieces produced are fed directly into a container and can optionally be mixed with additives and stressed in this container.

The apparatus is suitable for use in a process for comminuting recycled material, e.g. for comminuting composite materials, electronic scrap, e.g. printed circuit boards, batteries, optionally including housings of plastic and/or of metal.

The apparatus is furthermore set up for carrying out a method which, with a short duration, e.g. within a maximum of 1 h, a maximum of 30 min, a maximum of 20 min, a maximum of 15 min, a maximum of 10 min, preferably within a maximum of 5 min, a maximum of 3 min, a maximum of 120 s, a maximum of 60 s or a maximum of 30 s, results in mechanical stressing of the pieces, which are, for example, foodstuff pieces, e.g. until cell juice emerges and/or until softening of the foodstuff pieces, and/or in intensive mixing of the pieces in the container.

### STATE OF THE ART

It is known to use rollers or mills for comminuting solids and, in particular, to use food processors for comminuting solid foods, which have knives on a rotating roller or disc to which a feed chute is directed.

WO 2015/114118 A1 describes the production of meat products by stressing raw pieces of meat in a container which is driven along two axes in a forced reciprocating movement with a frequency of at least 0.5 Hz. The raw pieces of meat absorb e.g. aqueous or oily compositions or can stick together as a result of the stress.

EP 3 620 067 A1 describes a mixing and kneading process for a polymer with a further ingredient, at least one of which is liquid, by moving a container reciprocating at at least 1 Hz along two axes at different frequencies.

### TASK OF THE INVENTION

It has an object of the invention to provide an apparatus and a method which can be carried out with it, with which solid foodstuffs, e.g. vegetable raw foodstuffs, can be comminuted, in particular cut, and optionally subsequently be subjected to intensive mechanical stress and/or mixed.

### DESCRIPTION OF THE INVENTION

The invention achieves the object by the features of the claims and provides in particular a apparatus for comminuting solids into pieces, in particular solid foodstuffs into pieces of foodstuff, optionally subsequent mechanically stressing and/or mixing of the pieces, in particular pieces of foodstuff, and optionally additives, which has a container, for example with a cross-section of at least 10 cm in diameter, on the first terminal cross-sectional opening of which at least one cutting edge, which is for example a knife, is arranged, the first cross-sectional opening forming an inlet opening or optionally being covered by a first lid which has an inlet opening, wherein the container is driven in parallel or at an angle to the plane in which the first cross-sectional opening extends, to a reciprocating movement which may be linear, in particular driven by an eccentric drive, and which is preferably obtainable by superimposing the movement along at least two axes which are at an angle to one another, at the same, preferably different, frequencies, with a feed chute, the outlet opening of which is arranged in the region of the first cross-sectional opening and the opposite inlet opening of which is spaced from its outlet opening. The container can, for example, have a diameter of up to 100 cm, up to 70 cm or up to 50 cm or up to 30 cm.

The terminal second cross-sectional opening of the container opposite the first cross-sectional opening can be reversibly closed by a second lid or covered by a second lid, which can be firmly connected to the container wall.

The angle at which the container is driven to a reciprocating movement relative to the plane in which the first cross-sectional opening extends can be, for example, 5 to 45°, e.g. up to 30° or up to 10°.

Preferably, the feed chute is arranged perpendicular to the plane in which the first cross-sectional opening, optionally with a first cover, is driven for reciprocating movement.

Preferably, the apparatus has a housing cover that extends parallel to the plane and over the area in which the first cross-sectional opening is driven for reciprocating movement. Optionally, the feed chute is pivotable or fixed to the housing cover. Preferably, the housing cover is part of a housing that surrounds the space in which the container performs the reciprocating movement.

Preferably, the feed chute has a cross-section and a length along which a human hand cannot be moved to the outlet opening.

The container is generally preferably not driven for complete rotation, optionally the apparatus is set up for swivelling the container during the reciprocating movement, e.g. for swivelling reciprocating in the plane in which the container is driven for the reciprocating movement.

For the reciprocating movement of the container, the apparatus can have a manual drive, e.g. a drive crank, or at least one drive motor.

The apparatus has the advantage, due to the container being set up for reciprocating movement, that the pieces obtained, in particular foodstuff pieces, can be stressed and mixed immediately after cutting, so that they are immediately contacted with additives, in particular after the addition of additives. Additives for solids to be recycled can be, for example, water and organic solvents. Suitable additives for foodstuff pieces include food-grade acids or antioxidants in an aqueous or oily composition to treat cut surfaces of the foodstuff pieces immediately after cutting, in particular to prevent a browning reaction

Preferably, the drive for the container has a pivot arm, the first end of which is freely pivotably mounted in a first pivot bearing, which is a ball joint. The second end of the pivot arm is pivoted to the first end of a first lever, and the first lever is driven at its opposite second end by an eccentric drive for reciprocating movement. In this embodiment, the pivot arm is driven for reciprocating movement by means of only one lever, which is driven by an eccentric drive.

In a preferred embodiment, in addition to the first lever at the second end of the pivot arm, the first end of a second lever is pivotably articulated, which is arranged at an angle of 60 to 120° to the first lever. Preferably, the first and second levers are arranged in a plane which is approximately perpendicular to the extension of the first pivot arm, optionally parallel to the plane in which the frame part lies to which the at least one, preferably two drives are attached, which are eccentric drives. Alternatively, one or both of the first and second levers can be arranged at an angle of, for example, 85 to 45° or up to 60° to the longitudinal axis of the pivot arm. The first lever is driven by a first eccentric drive articulated at its second end for reciprocating movement along its longitudinal axis. The second lever is driven for reciprocating movement along its longitudinal axis by a second eccentric drive articulated at its second end. Thereby, the first lever and the second lever are set up for swivelling the first pivot arm in the pivot bearing and for swivelling the second end of the pivot arm along the longitudinal axes of the first lever and the second lever, wherein as a result of the swivelling in the first pivot bearing the second end of the first pivot arm moves reciprocating at greater and smaller spacings from the plane of the frame part.

Preferably, the container is detachably or fixedly attached to a container holder. The feed chute is preferably attached to a housing cover, which covers the area that is swept over during the reciprocating movement of the container, in particular along a trajectory curve.

Due to the reciprocating movement of the container along the feed chute, which is fixed in position, the cutting edge arranged at the first cross-sectional opening, hereinafter referred to as knife, is moved reciprocating relative to the feed chute and cuts solids fed through the feed chute into pieces, for example raw food materials into food pieces, which can move through the inlet opening into the container. Preferably, the inlet opening of the container is formed by the first cross-sectional opening of the container, which is only partially covered by the at least one blade, optionally a carrier carrying the at least one blade. The at least one knife and optionally a carrier supporting the knife can be arranged in the plane of the terminal first cross-sectional opening of the container or at spacing from the container. Preferably, the at least one knife is fixed to the container, or the at least one knife can be detachably latched to the container, for example by means of a bayonet catch.

Preferably, the container has at least two knives which are arranged at an angle to one another, e.g. at 60 to 120°, preferably 90° to one another, in particular in a common plane which is, for example, parallel to the plane of the first cross-sectional opening. Each of the knives can have a cutting edge which has regions projecting above a plane and regions lying below the plane in order to cut grooves with interposed projecting webs. With two knives arranged at an angle to each other, e.g. at 60 to 120°, preferably 90° to each other, and a reciprocating movement in each case offset, in particular perpendicular to one of the knives or to their cutting edge, along the outlet opening of the feed chute, cut surfaces with offset grooves and webs are produced, e.g. pieces with opposite cut surfaces whose grooves are offset by 60 to 120°, preferably by 90° to each other. Preferably, each knife has two opposing cutting edges, which can be formed, for example, by a one-piece or two-piece knife.

Preferably, the cutting edge or the opposing cutting edges of the at least one knife are arranged at an angle of less than 90°, e.g. 85° to 30° to the longitudinal axis of the reciprocating movement of the container in the region in which the feed chute is arranged.

Due to the apparatus being set up for reciprocating the container, to the first cross-sectional opening of which at least one knife with preferably two opposing cutting edges is attached, the apparatus is set up for cutting solids, in particular raw food materials, in each of the two directions of the reciprocating movement.

Optionally, the cross-section of the container is spanned by a wall that has protrusions arranged at intervals that protrude into the container volume, or is spanned by a smooth wall.

The container preferably has a round cross-section, or a cross-section that has at least 3, at least 4, at least 5, at least 6, at least 7 or at least 8 corners, e.g. a maximum of 20 corners in each case. The diameter of the container can, for example, be between 10 and 40 cm, e.g. 10 or 20 cm up to 35 or up to 30 cm in each case. The height of the container, determined perpendicular to the plane of its terminal cross-sectional opening or its inlet opening, can be, for example, 10 to 50 cm, optionally be equal to its diameter.

The cross-section, when reciprocating along trajectory curves, for example by reciprocating moving along two axes that lie at an angle to each other and in the plane of the cross-section of the container, results in a relative movement of the foodstuff pieces that have entered the container against the container wall in a continuous motion. It is assumed that the intensive stressing and effective mixing of cut pieces, in particular foodstuff pieces, by the method is also caused by the continuous movement encompasses the complete contents of the container, e.g. without allowing pieces or additives to partially deposit or separate in the container.

The projections protruding into the cross-section of the container can, for example, have a height from the wall of 1/30 to 1/1 or up to ½ or up to ⅕ or up to 1/10 of the diameter of the container, e.g. 1/20 to 1/1 or up to ½ of the diameter of the container, in particular a height of 0.1 to 20 mm, e.g. at least 2 mm, at least 3 mm, 4 mm or at least 5 mm, e.g. up to 18 mm or up to 15 mm in each case.

In an embodiment, the side surfaces of the protrusions merge continuously into the recesses formed between them.

In an alternative embodiment, the projections are arranged at a distance from the container wall, so that the side surfaces of the projections do not merge into the container wall or are not connected to the container wall. In this embodiment, the protrusions can be formed, for example, by a sheet metal that is arranged with a spacing from the container wall and has perforations, e.g. round through-holes or elongated through-holes. Such a sheet metal can, for example, be mounted at a spacing of 1 to 30 mm from the container wall, preferably parallel to the container wall, e.g. connected to the container wall by supports.

It has shown that protrusions that extend over the container wall into the cross-section of the container accelerate the mixing of ingredients at reciprocating movement of the container, e.g. in comparison with a cylindrical container with a flat wall.

Optionally, the wall of the container has a smooth and cylindrical inner surface.

Optionally, a removable grid is arranged in the container, which is optionally enclosed by a frame, wherein the grid or the frame has a circumference that clamps in the container parallel to the longitudinal axis or along the longitudinal axis of the container. The grid may consist of spaced, preferably parallel bars, or have crossed bars. In general, the grid can be formed from bars, preferably round bars, or a perforated sheet metal, optionally two parallel perforated sheet metals or bars arranged in two parallel planes.

The apparatus is set up for reciprocating movement of the container along a trajectory curve with a frequency of at least 1 Hz along two axes, each with a different frequency, over a path along each axis of preferably at least 2.5 mm, at least 1 cm, at least 2 cm or at least 3 cm or at least 10 cm, e.g. up to 50 cm, up to 30 cm, up to 20 cm or, in the case of shorter paths, up to 10 cm.

The reciprocating movement of the container can, for example, extend over a path of at least 5 mm, preferably at least 10 mm, preferably at least 2 cm, preferably at least 3 cm or at least 5cm, at least 10 cm or at least 15 cm, e.g. up to 40 cm, up to 30 cm or up to 20 cm or up to 15cm in each case. Further preferably, the reciprocating movement of the container is harmonious along a trajectory curve. The reciprocating movement of the container can be linear or non-linear or can be sinusoidal, loop-shaped or arcuate, preferably running along a trajectory curve which preferably lies in the plane in which the first cross-sectional opening extends.

This is because, in general, a non-linear axis of movement, preferably a reciprocating movement along a trajectory curve, which can be a Lissajous figure or hypocycloid, promotes a non-linear movement of the knife along the feed chute, so that solid foodstuffs are comminuted with a smoother cut. Furthermore, the non-linear reciprocating movement promotes uniform and intensive mixing, even with pieces of foodstuff that have a similar or identical specific weight and/or a similar size. Each axis of movement can be linear in itself, so that the non-linear movement of the container is generated by superimposing the movements along two axes of movement. Optionally, the reciprocating movement can also extend into a third dimension, perpendicular to the plane spanned by the first and second axes.

The container is driven for reciprocating movement along at least one trajectory curve which can be generated by superimposing the reciprocating movement along at least two axes which lie at an angle to one another, preferably two of the axes lying in the plane of the cross-section of the container, the reciprocating movement along each axis taking place at different frequencies and/or with a phase offset. The trajectory curve can be generated by superimposing the reciprocating movement along two or three axes at different frequencies and/or with phase offset and has a sequence of trajectory segments, at least one of which, preferably each, comprises or consists of exactly one complete reciprocating movement along the axis along which the reciprocating movement takes place at the lower frequency, wherein the superimposed reciprocating movements at the higher frequency or at the same frequency, in each case optionally with phase offset, are comprised along the other axis or axes. Therein, the lower frequency of the complete reciprocating movement forms the frequency of the sequence of trajectory segments. For each trajectory segment, a frequency ratio of the reciprocating movement along two axes of at maximum 1:20 or at maximum 1:15 or at maximum 1:10, at maximum 1:4 or at maximum 1:3 is preferred, more preferably between 1:1 and 1:2, even more preferably greater than 1:1 up to 1:2 or up to 1:1.5, e.g. with a frequency ratio of 1:1.001 to 1:2 or up to 1:1.5.

In the case of a trajectory curve that can be generated by superimposing the reciprocating movement along two axes at different frequencies and/or with a phase offset, the axes preferably lie in the plane of the cross-section of the container. In the case of a trajectory curve that is formed by superimposing the reciprocating movement along three axes, two of the axes preferably lie in the cross-sectional plane of the container and the third axis is at an angle to this cross-sectional plane. In general, the linear axes of movement are preferably at right angles to each other. In general, the trajectory curve does not include any rotation of the container about its own axis.

In general, the apparatus is set up to drive the container along a trajectory curve which is formed by superimposing the reciprocating movement of at least two superimposed linear axes which are at an angle to one another, the reciprocating movement along the linear axes taking place at different frequencies and/or with a phase offset. The linear axes, along which the superimposed reciprocating movements take place at different frequencies and/or with phase offset, form the trajectory curve along which the reciprocating movement of the container takes place, for which the apparatus is set up.

By moving the container along the trajectory curve, the apparatus is set up to accelerate the mixture relative to the container, so that solids and/or liquids contained in the container are sheared by the acceleration against the container wall and by the movement along or against the container wall and thereby are intensively mixed.

Due to the trajectory curve being adjustable or can be predetermined by the different frequencies and/or by the phase offset of the superimposed movements along the linear axes, the apparatus is set up for the reciprocating movement of the container along the trajectory curve and for the relative movement of the solids and/or liquids and the mixture with respect to the container.

Generally preferably, the container is not rotationally driven and is further preferably not or not fully rotatable, e.g. rotatable by a maximum of 30° or by a maximum of 20° or 10° about its centre axis. Generally preferably, the container is driven exclusively for a reciprocating movement along a trajectory curve driven by only one lever having an eccentric drive or driven along a trajectory curve, e.g. by a first and a second lever, each driven by an eccentric drive at different frequencies and/or with a phase offset.

The trajectory curve, which is adjustable or can be predetermined by the different frequencies that can be set for two levers and/or the phase offset of the superimposed movements along at least two linear axes, accelerates solids and/or liquids and the mixture of these relative to the container. The reciprocating movement of the container drives the solids and/or liquids and the mixture thereof to move against the inner wall of the container.

The angle of incidence and angle of emergence of the solids and/or liquids and the mixture of these against the container wall can be determined by the trajectory curve. In addition, the apparatus is optionally set up to move the container along the trajectory curve with adjustable or predetermined acceleration and speed. In that the apparatus is arranged for an adjustable or predetermined trajectory curve and/or for an adjustable or predetermined acceleration and/or for an adjustable or predetermined velocity along the trajectory curve of the reciprocating movement of the container, solids and/or liquids and the mixture thereof are driven with adjustable or predetermined acceleration and/or velocity relative to the container and allows for a predetermined or continuous adaptation of the method to the solids and/or liquids and to the mixture thereof.

In general, a trajectory curve can be formed by at least two superimposed individual oscillations, preferably a trajectory curve resembles the trajectory curve that can be generated by superimposing reciprocating movements along at least two linear axes of movement at different frequencies and/or by phase offset. A reciprocating movement along a trajectory curve that is similar to the reciprocating movement along intersecting linear axes of movement that are superimposed on each other have different frequencies and/or a phase offset to each other. In general, a trajectory curve is therefore optionally not a circular path.

The difference in frequencies can, for example, be at least 0.01 Hz and/or 0.01% to 900%. The phase offset of the reciprocating movements along the linear axes can be, for example, from 0.01° to 180°, preferably 1 to 179° of 360°, which corresponds to a complete reciprocating movement. In this case, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

The linear axes of movement are, for example, perpendicular or intersect at a different angle, e.g. 5° to 85° to each other, in particular in the plane of the cross-section of the container and/or perpendicular to a centre axis of the container. Optionally, the trajectory curve contains at least one straight-line section, the end of which is, for example, an apex of the path curve, at which the solids and/or liquids and the mixture thereof are accelerated away from the container wall or against the container wall.

For setting different frequencies and/or a phase offset of the superimposed reciprocating movements along at least two linear movement axes, these reciprocating movements can be coupled together by a transmission or a link guide and be driven by a motor. A transmission driven by a motor, which sets the reciprocating movement along the trajectory curve, can have a fixed transmission ratio between the superimposed movements along each axis, or an adjustable transmission ratio, e.g. a continuously or incrementally shiftable transmission. Optionally, the transmission can be slip-controlled, e.g. have a belt drive or be a friction gearbox.

The output rotational speed of the transmission, which drives the reciprocating movement of the container, is preferably at least 1 Hz, more preferably at least 2.5 Hz, more preferably at least 5 Hz, more preferably at least 7 Hz, e.g. up to 50 Hz, up to 40 Hz, up to 30 Hz, up to 20 Hz or up to 10 Hz. The output rotational speed of the transmission is equal to the frequency of the reciprocating movement.

Alternatively, the reciprocating movement along each of the linear axes of movement may be driven by a separate motor, wherein for the purposes of the invention the lower output rotational speed is the frequency of the reciprocating movement and forms the frequency of the sequence of trajectory segments. In any embodiment, the rotational speed of each drive motor may be controlled, fixed or variable over the duration of the method.

Therein, the apparatus allows the trajectory curve to accelerate the solids and/or liquids and the mixture of these in a defined direction to a specific location on the inner wall of the container. Therein, the geometry of the container and at its inner wall can support the mixing process in conjunction with the trajectory curve, so that the trajectory curve can be adjusted depending on the shape and size of the container cross-section.

Optionally, the apparatus is set up to change the trajectory curve of the reciprocating movement and/or the acceleration and/or speed of the reciprocating movement during the method, e.g. in a first phase to set the reciprocating movement along a first trajectory curve and with a first acceleration and speed and to set the reciprocating movement in a subsequent second phase along a changed trajectory curve and/or changed acceleration and/or speed.

Further optionally that the reciprocating movement is a linear reciprocating movement in a first phase and a reciprocating movement along merging trajectory curves in a second phase. The trajectory curve can, for example, be determined by a transmission that drives the movement of the container.

By adjusting the trajectory curve and acceleration of the reciprocating movement of the container, the apparatus allows a predetermined or dynamically variable and directed acceleration of the contents as process material relative to the container. In an embodiment, in which the container can be driven in a controlled manner in a first phase for a linear reciprocating movement, the apparatus is set up to move solids and/or liquids and the mixture thereof in perpendicular against the container wall with a controllable acceleration which is significantly greater than the acceleration due to gravity and is therefore essentially independent of the acceleration due to gravity, e.g. with a maximum acceleration of at least 15 m/s², preferably 25 m/s², preferably at least 50 m/s² or at least 100 m/s² or at least 200 m/s² or at least 350 m/s² e.g. up to 500 m/s² in each case.

In general, the apparatus can be set up to accelerate the container with a maximum acceleration of at least 20 m/s² or at least 100 m/s², e.g. at least 200 m/s², preferably up to 1000 m/s² or up to 300 m/s² along the trajectory segments, e.g. at an apex of the trajectory segments.

The container is preferably driven to a reciprocating movement with a maximum acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. up to 300 m/s²or 450 m/s², up to 260 m/s² or up to 250 m/s²along each of two axes. Generally preferably, in combination with the acceleration the container is driven to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. The path of the movement along at least one axis, preferably along each axis, is e.g. 0.1 cm to 24 cm.

The container can, for example, be driven to a reciprocating movement, which extends along each axis over a path of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container can be linear in a first phase, generally the trajectory curve is non-linear and can, for example, be sinusoidal, loop-shaped or arcuate, preferably running along a so-called Lissajous figure or hypocycloid, which preferably lies in a plane, respectively is two-dimensional, optionally three-dimensional. Preferably, the reciprocating movement is linear in a first phase and in a second phase along at least two merging, non-linear trajectory segments, each containing at least one apex, to form a trajectory curve. This is because a non-linear trajectory curve, e.g. a movement along a trajectory curve whose trajectory segments each have at least one apex, generally promotes an impact of solids and/or liquids and the mixture of these, e.g. in perpendicular to the container wall, as well as a movement along the container wall.

Preferably, the reciprocating movement comprises the reciprocating movement along a trajectory curve which comprises at least two, preferably at least three, more preferably at least four different trajectory segments, each of which has at least one apex and preferably merges into one another in chronological sequence, preferably in a programme-controlled manner. Each of the movement axes along which the movements are superimposed to form a trajectory curve can be linear or arcuate, so that the non-linear movement of the container along a sequence of trajectory segments is generated from the superimposition of the movements along two movement axes. The apices and intermediate sections of a trajectory segment are determined by the frequency difference and/or the phase position of the superimposed reciprocating movements along at least two axes. In general, the apparatus can be set up to change the frequency difference and/or the phase position during the reciprocating movement.

In general, the container wall is preferably the circumferentially closed wall of the container, which extends around a centre axis and between respective terminal opposite cross-sections or lids attached thereto. The container optionally has a circular cross-section that extends around a centre axis and is spanned by the container wall. Generally preferably, the terminal cross-sectional openings of the container are each covered by a lid, at least one of which optionally has a through opening.

Optionally, in particular for use in a continuous comminuting method, the terminal second cross-sectional opening of the container opposite the knife is open, in particular arranged below the knife. In this embodiment, the container is optionally arranged for movement along the reciprocating motion within an encompassing collecting apparatus which receives pieces emerging from the open terminal cross-sectional opening arranged opposite the knife. A collecting apparatus may be a housing or a hopper.

It is generally preferred that at least one trajectory segment has an apex at which the direction of the trajectory segment changes by at least 90°, more preferably by at least 120°, even more preferably by at least 180°, e.g. within at maximum 24.5%, at maximum 24%, at maximum 23%, at maximum 22%, at maximum 21%, at maximum 20%, at maximum 15%, or at maximum 10%, more preferably at maximum 5%, at maximum 3% or at maximum 2% or at maximum 1% of the length of a trajectory section. This is because an apex of the trajectory segment leads to a strong relative acceleration of the solids and/or liquids and the mixture of these against the container.

The control of the drive of the container is optionally controlled depending on the signal of a sensor, preferably an acoustic sensor, which picks up vibrations, in particular noises of the container during the reciprocating movement, in particular during the first and/or during the second phase. The acoustic sensor can, for example, be attached to the outer surface of the container or fixed at a spacing from the container in a position past which the reciprocating movement of the container passes. Preferably, the acoustic sensor is fixed at a small spacing, e.g. from 0.5 to 5 cm, from the apex of the reciprocating movement, e.g. fixed to a frame relative to which the container is moved along the trajectory curve. The acoustic sensor can be a vibration sensor, e.g. a microphone. In this embodiment, the control of the reciprocating movement can be set up, when the signal emitted by the acoustic sensor changes by a predetermined deviation within a predetermined time of the reciprocating movement, and/or when a predetermined signal emitted by the acoustic sensor is reached, to allow the reciprocating movement to run at a changed speed and/or with a changed phase offset and/or to control it from a linear movement into a trajectory curve, in particular to control it from a first phase to a second phase of the reciprocating movement.

The sensor can also be an optical sensor attached to the container, e.g. a turbidity sensor.

Optionally, a device for generating electrical voltage is attached to the container, in particular a device with a magnet and a coil arranged to move relative to the magnet, which are set up to generate electrical voltage at relative movement to each other. This device is preferably connected to a transmitter attached to the container by means of an electrical cable in order to apply electrical voltage to the transmitter. The transmitter is preferably connected to at least one of the sensors by means of a data line in order to receive sensor signals. Therein, the transmitter is set up, for example, to transmit received sensor signals. Furthermore, the sensor can be connected to the device for generating electrical voltage by means of an electrical line. In this embodiment, the device is set up so that a sensor attached to the container and a transmitter can be energized by the device for generating electrical voltage as soon as the container is moved along the trajectory curve. Accordingly, the device may be formed without an electrical line extending between a frame relative to which the container is moved and the container.

Preferably, the container has a second lid at its second cross-sectional opening, which can be opened or moved away from the inner volume in order to be able to open the inner volume for removing or dropping out or flowing out the mass subsequent to the reciprocating movement. Preferably, the container is arranged with its first cross-sectional opening above the second cross-sectional opening. In general, the container can optionally be used with a first lid arranged at the first cross-sectional opening for a batch-wise process after filling in pieces of foodstuff, which are produced immediately beforehand by cutting raw food materials fed through the feed chute by means of the knife attached to the first cross-sectional opening, wherein the pieces of foodstuff are subsequently stressed by reciprocating movement of the container and optionally mixed with added additives. Alternatively, the first cross-sectional opening can be closed by an upper lid that has no inlet opening, with subsequent reciprocating movement of the container and opening of a second lid to allow the foodstuff pieces to fall out.

Generally, preferably in the case of a container having at least a triangular cross-section or a polygonal cross-section, the movement can take place along a sequence of trajectory segments each having at least one apex, preferably each trajectory segment having a number of apices equal to the number of corners of the cross-section of the container. Alternatively or additionally, the number of apices of each trajectory segment can be equal to the number of corners of the cross-section of the container. The apices may, for example, comprise an angle that is at least twice as large, preferably at least three times as large, as the angle encompassed by one of the adjacent trajectory curves. Optionally, the feed chute is arranged in the region in which the trajectory curve has an apex.

The movement along two axes, respectively the reciprocating movement, can be driven by a drive motor or a hand crank, wherein the different frequencies of the movements along the axes are achieved, for example, by means of a sliding guide, an eccentric drive and/or by means of a transmission. Alternatively, the reciprocating movement can be driven by two controlled drive motors. A drive motor can be a linear drive, e.g. an electric or hydraulic or pneumatic linear drive, or a rotary motor.

The invention is now described in more detail with reference to the figures, which schematically show in

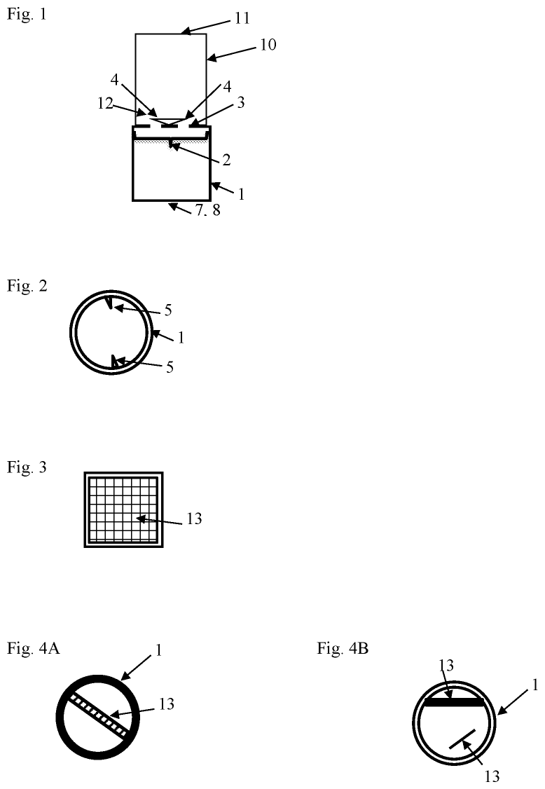

FIG. 1 an embodiment of the apparatus,

FIG. 2 embodiments of projections on the container wall,

FIG. 3 a grid to be reversibly arranged in a container,

FIGS. 4A and 4B embodiments of a container with a grid arranged therein,

FIG. 5 a sectional view of an embodiment of a container with a drive, and

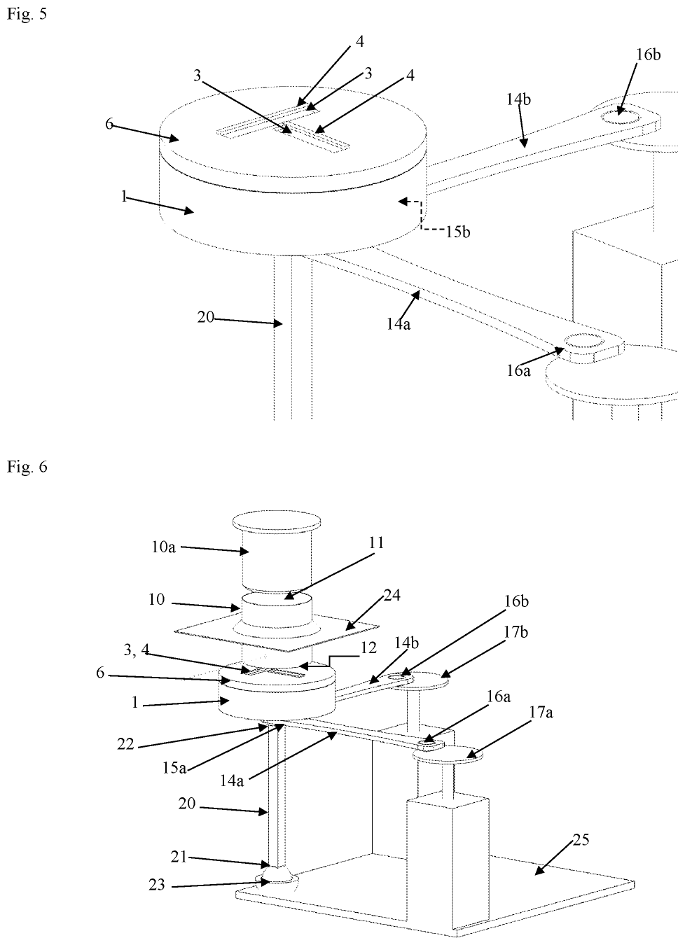

FIG. 6 an embodiment with a preferred drive.

In the figures, identical reference numbers denote elements with the same function. FIG. 1 shows a container 1 in longitudinal section, the first terminal cross-sectional opening 2 of which has inlet openings 3. A knife 4 is attached to the terminal cross-sectional opening 2. A feed chute 10 has an inlet opening 11 and an outlet opening 12 adjacent to region in which the container 1 is driven to perform a reciprocating movement, in particular a trajectory curve. The second cross-sectional opening 7 opposite the first cross-sectional opening 2 is reversibly or firmly closed by a second lid 8.

FIG. 2 in cross-section shows an embodiment of the container 1 with projections 5 that protrude into the container volume.

FIG. 3 shows a grid 13, which is enclosed by a frame 14 and can be arranged along the longitudinal centre axis of the container 1.

FIG. 4A in cross-section shows of the container 1 with a grid 13 arranged along its longitudinal centre axis.

FIG. 4B shows an alternative arrangement of grids 13, which are arranged at a distance from the longitudinal centre axis of the container 1.

FIG. 5 shows an embodiment of the container 1, the first terminal cross-sectional opening of which is covered by a first lid 6, in which two knives 4 offset at 90° to each other and an inlet opening 3 parallel to each knife 4 are arranged. The container is connected, for example by means of a container holder, to the second end 22 of a swivelling arm 20, the opposite first end 21 of which is pivotably mounted. The drive has a first lever 14a, which is driven for reciprocating movement by a first eccentric drive 17a, and a second lever 14b, which is driven for reciprocating movement by a second eccentric drive 17b.

FIG. 6 shows the container 1 of FIG. 5, wherein the feed chute 10 is arranged at a distance from the first lid 6 in the region in which the first lid 6 or the container 1 moves, at least in sections, during the reciprocating movement. The feed chute 10 is arranged on and through a housing cover 24. For moving solids, e.g. solid foodstuffs, the apparatus preferably has a plunger 10a slidable along the feed chute 10.

The pivot arm 20 is freely pivotably mounted with its first end 21 in a pivot bearing 23, which is preferably a ball joint or universal joint. The second end 22 of the pivot arm 20 is pivotably hinged to the first end 15a of the first lever 14a and pivotably hinged to the first end 15b (concealed in FIG. 6) of a second lever 14b, which is arranged at an angle of 60 to 120° to the first lever 14a. As preferred, the first and second levers 14a, 14b are arranged in a plane which is approximately perpendicular to the extension of the pivot arm 20, optionally parallel to the plane in which the frame part 2 lies. Alternatively, one or both of the first and second levers 14a, 14b can be arranged at an angle of, for example, 85 to 45° or up to 60° to the longitudinal axis of the pivot arm 20. The first lever 14a is driven reciprocating movement along its longitudinal axis by a first eccentric drive 17a articulated at its second end 16a. The second lever 14b is driven to reciprocating movement along its longitudinal axis by a second eccentric drive 17b articulated at its second end 16b. Thereby, the first lever 14a and the second lever 14b are set up for swivelling the pivot arm 20 in the pivot bearing 23 and for swivelling the second end 22 of the pivot arm 20 along the longitudinal axes of the first lever 14a and of the second lever 14b, so that the apparatus is set up to reciprocatingly move the second end 22 of the pivot arm 20 from a greater distance to a smaller distance to the outlet opening 12 of the feed chute, reciprocatingly to the plane of the frame part 25 and to the plane of the housing cover 24, by means of the swivelling in the pivot bearing 23.

Reference sign:

| | |
|---|---|
| 1 | container |
| 2 | terminal cross-section opening |
| 3 | inlet opening |
| 4 | cutting edge, knife |
| 5 | projection |
| 6 | first lid |
| 7 | second terminal cross-section opening |
| 8 | second lid |
| 10 | feed chute |
| 10a | plunger |
| 11 | inlet opening |
| 12 | outlet opening |
| 13 | grid |
| 14a | first lever |
| 14b | second lever |
| 15a | first end of the first lever |
| 15b | first end of the second lever |
| 16a | second end of the first lever |
| 16b | second end of the second lever |
| 17a | first eccentric drive |
| 17b | second eccentric drive |
| 20 | pivot arm |
| 21 | first end of the pivot arm |
| 22 | second end of the pivot arm |
| 23 | pivot bearing |
| 24 | housing cover |
| 25 | frame part |

1. An apparatus for comminuting solids into pieces, comprising:
a cutting edge and an inlet opening arranged on a first terminal cross-sectional opening of the container,
drive configured to drive the container to a reciprocating movement parallel to or at an angle to a plane in which the first cross-sectional opening extends,
a feed chute comprising an outlet opening arranged in a region of the first cross-sectional opening and an opposite inlet opening spaced from the outlet opening.

2. The apparatus according to claim 1, wherein the first cross-sectional opening forms the inlet opening and the cutting edge, wherein the cutting edge is arranged in the plane of the first cross-sectional opening or inside the container.

3. The apparatus according to claim 1, wherein the first cross-sectional opening is covered by a first lid, wherein the inlet opening and the cutting edge are arranged in a region which extends from the plane of the inlet opening into the container.

4. The apparatus according to claim 1, wherein the cutting edge comprises at least two cutting edges arranged at an angle of 60-120° to one another in a common plane at the first terminal cross-sectional opening.

5. The apparatus according to claim 1, wherein the driver is configured to drive the container a reciprocating movement which is linear or is along a trajectory curve obtainable by superimposing movement along at least two axes, which are at an angle to one another, at different frequencies.

6. The apparatus according to claim 5, wherein the trajectory curve comprises a sequence of trajectory segments which can be generated by superimposing the reciprocating movement along at least two axes with different frequencies and/or with phase offset and which each comprise exactly one complete reciprocating movement along the axis along which the reciprocating movement takes place with the lower frequency and each having at least one apex in which the direction changes by at least 90° within a maximum of 24.5% of the length of a trajectory segment.

7. The apparatus according to claim 6, characterized in that the outlet opening is arranged in the region of the at least one apex.

8. The apparatus according to claim 1, wherein the drive comprises a motor or a hand crank, wherein the drive couples superimposed reciprocating movements along at least two linear axes of movement to one another by a transmission or a link guide.

9. The apparatus according to claim 1, wherein a terminal second cross-sectional opening of the container opposite the first cross-sectional opening is configured to be reversibly closed by a second cover or is covered by a second cover which is firmly connected to the wall of the container.

10. The apparatus according to claim 1, comprising a grid configured to be reversibly arranged in the container and has a circumference which clamps in the container parallel to the longitudinal axis or along the longitudinal axis of the container.

11. The apparatus according to claim 10, wherein the grid consists of spaced bars or comprises crossed bars which are formed from round bars or of a perforated sheet metal.

12. The apparatus according to claim 1, wherein the drive comprises a pivot arm, a first end of which is pivotably mounted in a pivot bearing and an opposite second end of which is attached to the container, with a first lever attached to the second end driven by a first eccentric drive configured for linear reciprocating movement.

13. The apparatus according to claim 1, wherein the drive comprises a pivot arm, a first end of which is pivotably mounted in a pivot bearing and an opposite second end of which attached to the container, with a first lever and second lever attached to a second end of the pivot arm, which are arranged at an angle of 30 to 150° to one another, wherein the first lever is driven by a first eccentric drive configured for reciprocating movement and the second lever is driven by a second eccentric drive configured for reciprocating movement.

14. The apparatus according to claim 13, wherein the first eccentric drive and the second eccentric drive are connected by a transmission which is driven by exactly one motor.

15. The apparatus according to claim 1, comprising a electrical voltage generator attached to the container, the generator comprising a magnet and a coil arranged movably relative to the magnet configured to generate electrical voltage upon movement relative to one another, the generator being connected by an electrical line to a transmitter attached to the container, wherein the transmitter is connected to at least one sensor by of a data line in order to receive sensor signals and the transmitter is set up to transmit received sensor signals, wherein the sensor is connected to the generator by an electrical line.

16-17. (canceled)
